(19) United States
(12) Patent Application Publication
(10) Pub. No.: US 2013/0037212 A1
(43) Pub. Date: Feb. 14, 2013

(54) MACHINING DEVICE

(71) Applicant: Johann Maischberger, Dinkelscherben (DE)

(72) Inventor: Johann Maischberger, Dinkelscherben (DE)

(21) Appl. No.: 13/643,702

(22) PCT Filed: Apr. 27, 2011
(86) PCT No.: PCT/EP11/56649

§ 371 Date: Oct. 26, 2012

(30) Foreign Application Priority Data
Apr. 27, 2010 (DE) 202010005313.7

(51) Int. Cl. B32B 37/12; B32B 37/06; B32B 38/18

(52) U.S. Cl. 156/322; 156/538; 156/378; 156/499; 156/60

(57) ABSTRACT

A device and method are provided for the web-like machining of workpieces (3), in particular for applying a medium (2) to a workpiece (3). The device includes a machining tool (15) and a media supply unit (16). The machining tool (15) is guided relative to the workpiece (3) by a multi-axis manipulator (13) having one or more driven flexible axes (n) (I-VII).

### CROSS REFERENCE TO RELATED APPLICATIONS

This application is a United States National Phase application of International Application PCT/EP2011/056649 and claims the benefit of priority under 35 U.S.C. §119 of German Patent Application DE 20 2010 005 313.7 filed Apr. 27, 2010, the entire contents of which are incorporated herein by reference.

### FIELD OF THE INVENTION

The present invention pertains to a processing device, especially an application device, along with the method for processing. The device includes a processing tool, a media supply unit and a moving means for generating a relative motion between medium and workpiece.

### BACKGROUND OF THE INVENTION

Tape application systems known in practice for adhesive or sealing tapes usually operate in two-dimensional application, wherein flat tapes are applied to flat workpiece surfaces. If profiled tape sections are applied, these are processed in their predetermined shape.

Such a tape application device is known from DE 20 2007 003 696 U1. It comprises an application) tool and a media supply unit, which can be attached together to the hand of a usual industrial robot. The tape application device has a considerable weight and is moved by the robot controlled by means of a preprogrammed path relative to the workpiece being held stationary at a carrier. The robot has axes that can be actuated such that it assumes accurate positions.

### SUMMARY OF THE INVENTION

An object of the present invention is to provide a better processing technique, especially application technique.

The processing technique according to the invention, i.e., the processing device and the processing method, have the advantage that it makes possible processing in space and especially processing in space of media at a workpiece fold The workpiece may have a contour variable in space with arches, corner areas and other 3D shape changes fold Furthermore, it is possible to deform the medium applied, which may be, for example, a web-shaped medium, especially a tape, in space and to apply it with a correspondingly altered shape.

Another advantage of the processing technique being claimed is the high precision of processing, especially of the application of media fold The multiaxial manipulator with the flexible axis or axes can function like the arm and hand of a human being fold It needs to carry only a relatively lightweight application tool, and heavier parts of the media supply unit may be arranged separately from the manipulator and do not have to be moved along fold The application tool may have a reduced function and can ensure only the application of media and possibly deformation and application as well as possible pressing on of the medium fold It may, furthermore, have a design and a weight that are also suitable for manual operation, so that the tool can also be held by the hand and the application may be carried out by hand or with the manipulator as desired.

Due to the driven flexible axis (axes), the manipulator can guarantee constant and error-free media application. The flexible axis (axes) has (have) an active compliance, with which the axis (axes) and hence also the manipulator can yield under the action of an acting force. For example, pure force regulation or a combination of position regulation and force regulation can be employed in case of active compliance.

The application is possible at a stationary workpiece and, as an alternative, also at a moving workpiece. A corresponding moving device, which ensures a relative motion between the medium and the workpiece, is provided for this.

The multiaxial manipulator may correspondingly be arranged stationarily or nonstationarily.

Its flexible axis (axes) makes (make) possible an elastic yielding of the application tool. The application force, especially the pressing force, can be maintained at a predetermined value and especially at a constant value. The manipulator may have, besides, a position control, with which the axis (axes) and the application tool can return into the preset working position after a possible yielding.

Due to the multiaxial manipulator with the flexible axes, which can be controlled such that they assume accurate positions, the application tool can also follow complicated shapes and contours of the workpiece and of the processing path and make possible three-dimensional application with high precision. Another advantage is the facilitated teachability of the manipulator, which is preferably programmed for the predetermined path or position. Due to the flexible axes, the manipulator with the attached application tool may possibly be guided by hand, the axis positions being stored in a path or position program. Despite the fact that the workpiece-specific and application-specific path is followed, the application tool is able to yield in case of possible errors in the path or other position or shape errors due to the axes being flexible. Tolerances of the workpiece can also be absorbed hereby. If the workpiece is moved by a second manipulator in the space, the path or positioning errors of that manipulator can be compensated by the flexible axes.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of an application device for a tape-like medium;

FIG. 2 is an enlarged view of an application tool with cut-away view of a multiaxial manipulator with flexible axes;

FIG. 3 is an enlarged view of a multiaxial manipulator for guiding the application tool;

FIG. 4 is a variant of the processing device from FIG. 1;

FIG. 5 is view of an applied adhesive tape as well as of a fold

FIG. 6 is another view of an applied adhesive tape as well as of a fold; and

FIG. 7 is another view of an applied adhesive tape as well as of a fold

### DESCRIPTION OF THE PREFERRED EMBODIMENTS

Referring to the drawings in particular, the present invention pertains to a processing device (1) for the preferably web-shaped processing of workpieces (3). It is preferably designed as an application device for applying a medium (2) to a workpiece (3). Furthermore, the present invention pertains, furthermore, to a processing or application method.

The processing of the workpieces may pertain to different processes and methods. In the preferred embodiment shown, a medium (2) is applied to a workpiece (3) along a processing or application path (4). This application may take place continuously or intermittently, i.e., preferably in sections of the path. Punctiform application of medium may be possible as well. The medium (2) may have any desired consistency and form and may consist of any desired and suitable materials.

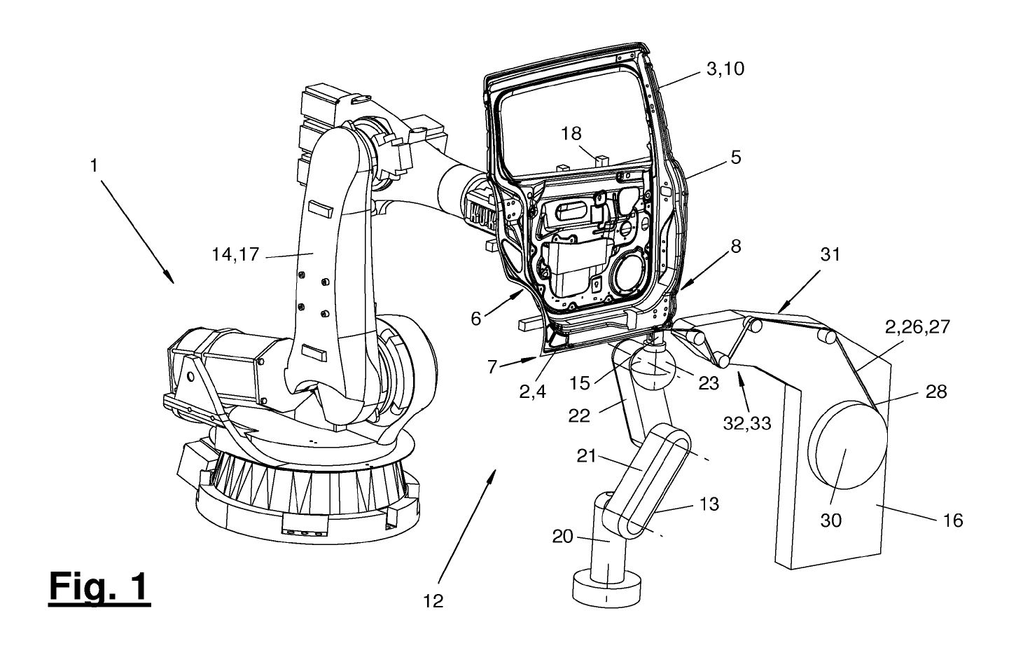

FIG. 1 shows in a perspective view an exemplary embodiment for an application device (1). Medium (2) is a web-shaped medium (26) in this case, especially a flat or profiled tape. Tape (26) has, e.g., an adhesive tape and possibly one or more cover tapes (28) applied thereto. Medium (2), especially tape (26) or adhesive tape (27), shall be applied to the workpiece (3) on a processing path (4). This processing path (4) may have a three-dimensional shape and may have an interrupted or uninterrupted course. Medium (2), especially tape (26) or adhesive tape (27), may be deformed in space from its originally flat shape. It may possibly also be stretched and/or upset if it has a corresponding elasticity. Tape (26, 27) may have at least flexural elasticity and tensile strength or elongation elasticity.

The processing or application device (1) has a processing tool (15), a media supply unit (16) and a moving device (12) for generating a relative motion between medium (2) and workpiece (3). These may have various designs and operate in various ways.

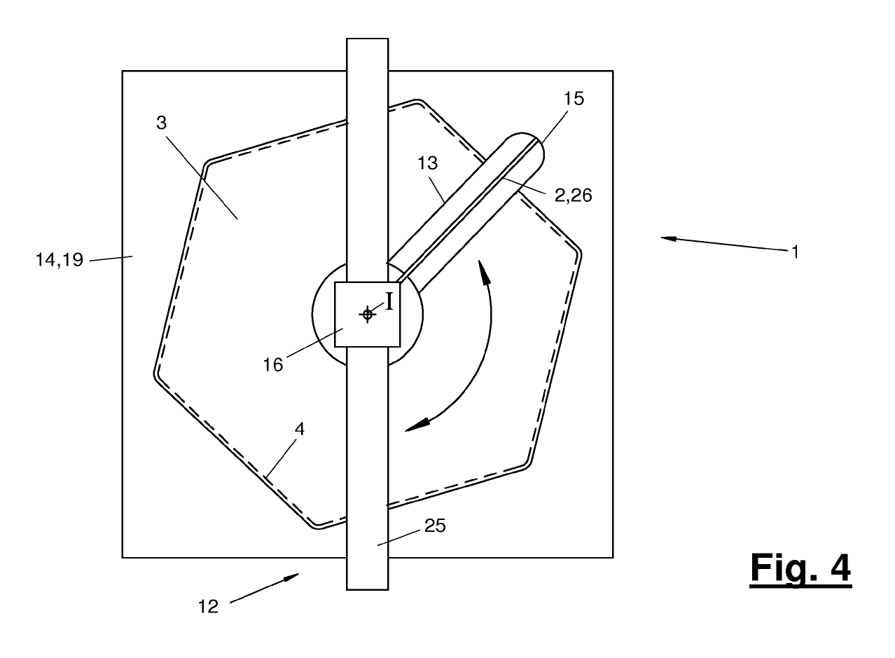

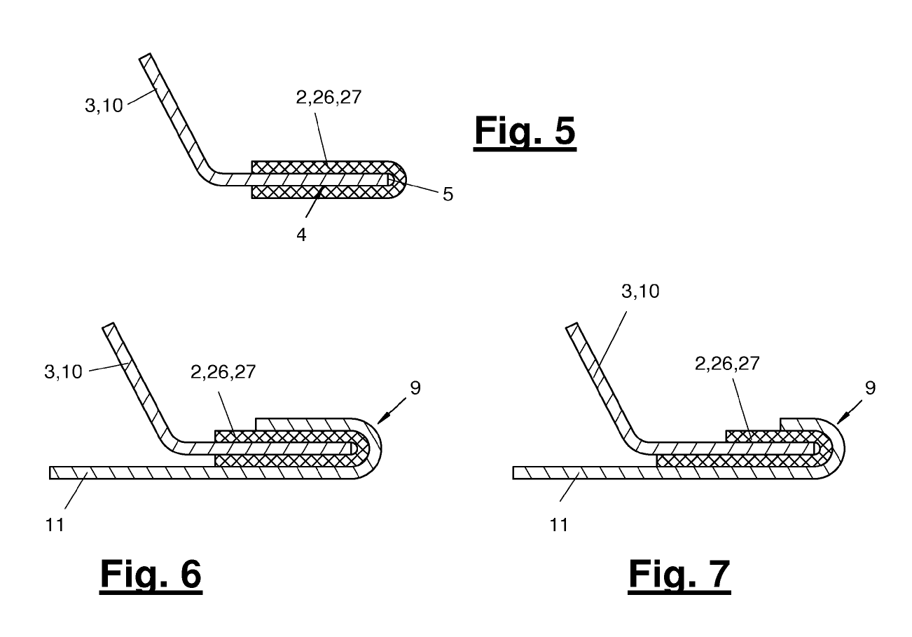

Workpiece (3) may be of any desired type, shape and size and consist of any desired materials. It may comprise one part or a plurality of parts. In the exemplary embodiments shown in FIGS. 1 and 4, it is a body part made of metal, especially the inner part (10) of a side door of a motor vehicle. Processing path (4) is defined in these exemplary embodiments by the subsequent formation of a hem or fold (9) shown in FIGS. 5 and 6, which is formed on the finished door. On the inner part (10) being shown, the processing path (4) extends at the outer edge (5) of said inner part. If the workpiece (3) has openings, a medium (2, 26, 27) may be applied at this opening edge as well. Edge (5) may have a nonlinear course in the longitudinal direction with curvatures.

As is illustrated in FIG. 1, the processing or application path (4) may have one or more arches or curves (6), one or more corner areas (7) with smaller radii of curvatures and/or one or more character lines (8). The latter may be, e.g., beads or kink lines on the outer body surface or door surface.

Moving device (means) (12) is formed in the exemplary embodiment shown in FIGS. 1 through 3 by a multiaxial manipulator (13) for guiding an application tool (15) and by a holding means (14) for the workpiece (3), which holding means (14) comprises a multiaxial manipulator (17) with a gripping means (18) in this exemplary embodiment. Manipulator (17) is designed, e.g., as an industrial robot, especially as an articulated arm robot having six axes. It may otherwise have any designed number and combination of axes that can be driven to perform rotary and/or translatory motions in a controlled manner. By means of the gripping means (18), it guides the workpiece (3) picked up along a predetermined path programmed in the robot control in relation to a processing or application tool (15) being held by the other manipulator (13). The other manipulator (13) and the processing or application tool (15) can assume and hold a preset position, and yielding or compensating motions are possible.

In a variant of the embodiment according to FIG. 1, which is shown and will be described in more detail below, the other manipulator (13) may be arranged at another site and have a different orientation, in which case it is attached, e.g., to a wall or a base laterally or suspended and has a horizontal or oblique orientation. Furthermore, the other manipulator (13) may perform independently controlled motions with its tool (15) relative to the workpiece (3) and possibly relative to the processing path (4). The motions of the workpiece and tool brought about by the manipulators (13, 17) may be superimposed to one another.

FIG. 4 shows a variant of the processing device or application device (1) according to FIG. 1. Holding means (14) is stationary in this embodiment and comprises, e.g., a table or a frame-like carrier (19) with suitable clamping means or other mounting means for a workpiece (3). Workpiece (3) is being held stationarily here, while the manipulator (13) with the processing or application tool (15) is moved relative to workpiece (3) and performs said relative motion of the moving means (12).

In a variant of the embodiment according to FIG. 4, the holding means (14) shown there may have one or more motion axes, and, e.g., the table (19) shown has an axis of rotation or sliding axis. As an alternative or in addition, holding means (14) may have a tilt axis in order to bring the workpiece (3) with the respective affected area of the processing path (4) into a more readily accessible position that is suitable for application.

In the embodiment according to FIG. 4, manipulator (13) is arranged above holding means (14). The manipulator may be fastened now to a suitable carrying means (25), e.g., a portal, and assume, for example, a suspended position. It may rotate about a vertical axis (I) and reach all edge areas of the workpiece (3) or a processing path (4) located there with its tool (15) in case of an essentially central arrangement.

Manipulator (13) is arranged at the bottom in the embodiment shown in FIG. 1 and assumes a vertical and possibly stretched position for the application process. It comprises a plurality of links (20, 21, 22, 23), which are connected to one another in an articulated manner and are provided with axis drives, and the last link (23) of which has a connection (34) for fastening the application tool (15). Manipulator (13) holds the tool (15) from below and presses it against the workpiece (3) and possibly against the processing path (4).

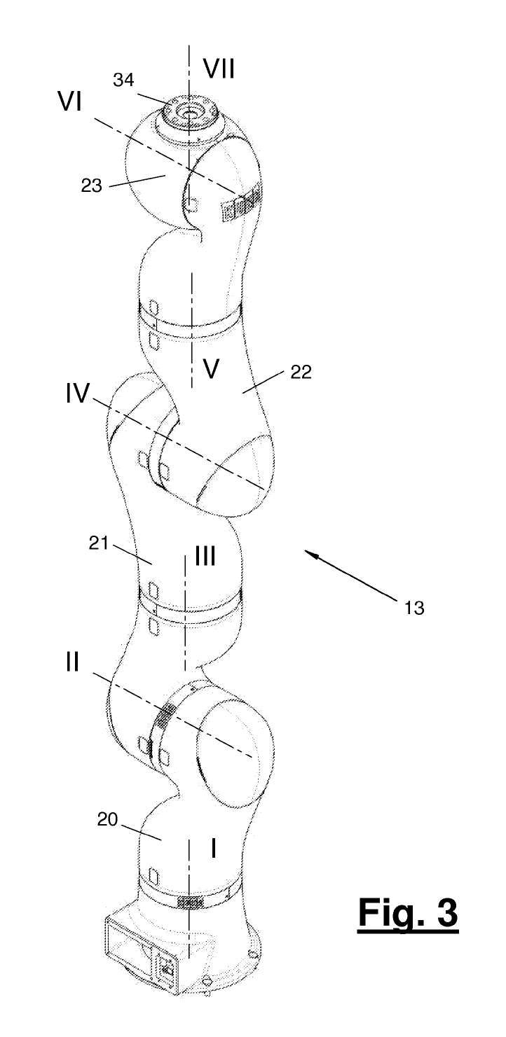

Manipulator (13) has one or more elastic axes (I-VII) and has one or more controllable or regulatable axis drives, which may be integrated in the articulated connections between the links (20, 21, 22, 23). Furthermore, the elongated links (20, 21, 22, 23) may be movable per se according to FIG. 3 and have axes directed along their extension, especially axes of rotation, with corresponding drives.

FIG. 3 shows manipulator (13) in the stretched position with the chain of the links (20, 21, 22, 23), which are connected to one another in an articulated manner, and with the driven axes (I-VII) of said links. Links (20, 21, 22, 23) are directed obliquely in relation to one another, which in the stretched position still allows yielding motions of the manipulator (13) and of the tool (15) thereof in the stretching direction, e.g., in the vertical or oblique direction.

In the exemplary embodiment shown in FIG. 3, manipulator (13) has seven axes (I-VII), all of which are designed as axes of rotation. As an alternative, it may have a different number, arrangement and design of axes. The axes may be designed as rotatory and/or translatory axes. All of them or only some of them may be flexible. FIG. 1 shows a modified embodiment with five rotatory axes. The links (21, 22) lack the internal axis of rotation in this embodiment.

A manipulator (13) may also have a different number of axes, e.g., one, two, three, four, six or even more than seven flexible axes (I-VII). The flexible axis (axes) (I-VII) is (are), e.g., a rotatory axis (rotatory axes). As an alternative or in addition, one or more translatory and possibly likewise flexible axes may be present. A manipulator (13) may have, besides, one or more rotatorily and/or translatorily driven axes without flexibility and, e.g., with exact position control or regulation.

Manipulator (13) has a control unit, not shown, and can be programmed. It is used to handle and position the application tool (15) relative to the workpiece (3). The axes or joints are flexible in the above-mentioned manner and permit yielding motions of the application tool (15), and the direction of yielding is directed, e.g., at right angles to the local shape of the workpiece (3) or of the processing path (4). In the embodiments shown in FIGS. 1 and 3 with the vertical orientation of the manipulator and especially with the stretched position, the flexibility may be given in the vertical direction. In the embodiment according to FIG. 1, manipulator (13) holds the application tool (15), e.g., in a preset height position and possibly also in a certain rotated and/or tilted position relative to the workpiece (3), so that it has the correct orientation for the local shape of the processing or application path (4).

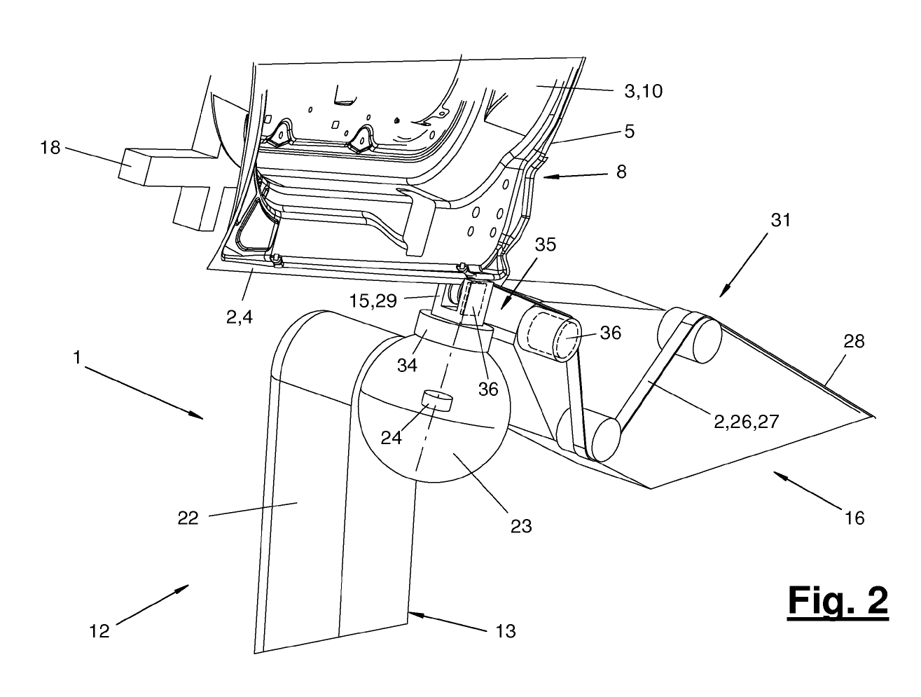

As is illustrated by the schematic view in FIG. 2, one or more sensors (24) or other devices for determining the occurring loads may be arranged at the links (20, 21, 22, 23) and especially in the area of the motion axes (I-VII) thereof. These may be especially forces or torques introduced by the process from the outside via the processing or application tool (15). Sensors (24) are coupled with the manipulator control or with individual axis controls and the axis drives.

Manipulator (13) may have one or more force-controlled or force-regulated axes (I-VII) and corresponding axis drives. As an alternative, a combined force and position control or regulation is also possible. As a result, a predetermined pressing force of the processing or application tool (15) on the workpiece (3), especially on the processing bath (4) of said workpiece, can be set. The pressing force may be set in a plurality of directions or spatial axes. This pressing force can also be kept constant in one or more directions by means of this force regulation. This makes possible a flexible axis design, in which case the tool (15) can yield in case of possible imprecisions of the workpiece (3) or of the processing path (4) due to a corresponding yielding of one or more axes (I-VII). Such imprecisions may be caused, e.g., by tolerances in shape and/or positioning. Possible shape projections at the processing path (4), e.g., an overdimension at the workpiece edge (5), can, e.g., push the tool (15) away during the motion of the workpiece.

Manipulator (13) may have a spring function, in which case it adjusts the tool (15) to the corresponding contour of the workpiece (3) or of the processing path (4). When the above-mentioned imprecision of shape, e.g., the overdimension at the edge, is overcome, the workpiece (3) returns into the desired position due to a corresponding axis control. This is achieved, e.g., by the axes (I-VII) involved in the yielding motion and possibly also other axes being moved back again during the force regulation until the preset external load is again present.

In the above-described exemplary embodiment, the processing or application tool (15) is pressed to the workpiece (3) or to the processing path (4) with a preset force acting in one direction or in a plurality of directions. These preset pressing forces are manifested in the above-mentioned preset load for the different axes (I-VII) or links (20, 21, 22, 23).

In another variant, the processing or application tool (15) can be held without force at the workpiece (3) or processing path (4), and said imprecisions are manifested in a contact and a build-up of forces, which is eliminated again by the flexibility of one or more axes (I-VII).

Manipulator (13) may have a programmable manipulator control. Positions for the different axis positions and for the tool (15) may be preset in the control. Manipulator (13) may thus have a position control. A corresponding tool position can be preset and stored in the control program for each point of the processing path (4), e.g., in the embodiment according to FIG. 1 as a function of the motion of holding means (14), especially of manipulator (17) and of the workpiece motion (3) resulting therefrom. Manipulator (13) with its flexible axes (I-VII) seeks to run into this position, which depends on the relative motion of the processing path (4) in relation to the tool (15). The control unit of manipulator (13) may be connected or possibly also integrated for this purpose with the control unit of holding means (14), especially of manipulator (17).

From the viewpoint of, e.g., design and control engineering, manipulator (13) may be designed corresponding to DE 10 2007 063 099 A1. The design embodiment of the link or axis drives with the force control or force regulation may be designed, for example, corresponding to DE 10 2007 014 023 A1 or DE 10 2007 028 758 B4.

10046] For guiding the processing or application tool (15), manipulator (13) has a number of significant functions and advantages. It offers a redundancy due to a plurality of axes, e.g., the five or seven axes shown. This improves accessibility and the precision of positioning of the tool (15). It has a programmable rigidity, which may be optionally axis-specific and/or Cartesian. Force or torque sensors in or at each axis and a fast control cycle are advantageous for this. An active oscillation amplitude and an especially good motion performance also result from this configuration. Manipulator (13) can perform high-performance, force-controlled processes and makes it possible due to its mobility to simplify the processing or application tool (15) and to reduce the weight of same. The auxiliary axes present in some cases in prior-art application tools are eliminated, and the corresponding mobilities are assumed by manipulator (13).

Further advantages of manipulator (13) are in its low weight and its small size. The working range can be markedly reduced compared to conventional articulated arm robots and especially compared to the robot (17) for moving the workpiece. The manipulator (13) shown in the different exemplary embodiments may have a resulting arm length of about 1 m and preferably 0.7 m to 1.2 m, e.g., in its stretched position, with a corresponding diameter of the work area. Manipulator (13) does, furthermore, offer a low power consumption, and this as well as the low weight result in a high degree of mobility. The small and lightweight manipulator (13) is, moreover, flexible in terms of location and may be mounted in any desired and suitable position in the above-mentioned manner. In addition, high safety, especially high safety against accidents in case of a possible contact with a worker, is guaranteed due to the flexibility of its axes (I-VII).

As is illustrated by FIGS. 1 and 4, the media supply unit (16) may be arranged such that it is separated in space from the manipulator (13) and from the processing tool (15). The weight of the media supply unit (16) does not therefore have to be moved along by the manipulator (13). It is possible, in particular, in the embodiment being shown to arrange the media supply unit (16) stationarily. If needed, the media supply unit (16) may have one or more motion axes of its own.

Media supply unit (16) may have various designs and any desired and suitable design according to the particular medium (2). It offers, e.g., a media supply (30), especially a tape supply, and a feed means (31) for the medium (2, 26) to the processing or application tool (15) at manipulator (13). The media supply unit (16) may have, e.g., a pull-off means (32) for a media part and may also have a disposal means (33) for media parts. As an alternative or in addition, the media supply unit (16) may have further components.

In the exemplary embodiment shown in FIGS. 1 and 2, a web-shaped medium (26) is applied to the workpiece (3) and to the processing path (4) thereof. This is, e.g., a tape. This may contain especially an adhesive tape (27), which is possibly provided with a detachable cover tape (28) on one side or on both sides. The media supply (30) may be designed as a tape supply, especially as a rotatable roll, which may possibly be provided with a drive, wherein said feed means (31) may have a plurality of guide and drive rollers and have, besides a means for transporting the tape (26), especially the adhesive tape (27), to the application tool (15). The cover tape (28) can be detached from the adhesive tape (27) prior to the application by means of a pull-off means (32) indicated only schematically by an arrow in FIG. 1 and picked up by means of a disposal means (33), e.g., an empty take-up roll, and made available for disposal.

Application tool (15) is designed for a web-shaped medium (26), especially for a tape, and has a guide means (29) for applying the medium (2, 26, 27) to the workpiece (3) or to the processing path (4). If a three-dimensional contact is necessary, guide means (29) may also have a suitable design for deforming the medium (2, 26, 27). For example, an originally flat and plane tape (26, 27) is bent here to a U shape about a longitudinal axis. Another type of profiling of the tape (26, 27) may now take place as well. Guide means (29) may be designed, e.g., as a rotatable roller with a grooved jacket for deforming the tape and possibly provided with a controlled rotating drive. As an alternative, guide means (29) may be designed as a manipulator-guided shaped part) without a motion axis of its own.

The deformation of the tape (26, 27) may be supported by additional measures, e.g., heating. A heated tape (26), especially an adhesive tape (27), can be permanently deformed more easily and retains the desired shape during application. Heating may be carried out in various manners, e.g., conductively, inductively, by infrared radiation or the like. Heating may take place at and/or in front of the guide means (29), with a corresponding heating means (36), shown schematically in FIG. 2, being arranged in a corresponding location at the guide means (29) and/or at the media supply unit (16), possibly after the pull-off means (32).

FIGS. 5 through 7 illustrate such an application. This is the formation of one or more folds (9) on the outer edge of a workpiece or component, e.g., a side door of a vehicle here. A corresponding fold (9) may also be present, for example, at the edge of a window or door cutout. For example, an inner part (10) and an outer part (11) are involved in the formation of the fold. The outer part (11) is bent over and hemmed with its end projecting at the edge and extends over the edge of the inner part (10) while forming a fold (9).

Tape (26) may be, e.g., an adhesive tape or sealing tape, which is placed around the edge (5) of the inner part (10) and extends in a U-shaped pattern around this flange-side edge (5). The adhesive or sealing tape can mutually seal and close the fold (9) and the parts (10, 11). Tape (26) may have an adhesive action. In addition, it may possibly change its shape, having, e.g., an overdimension at the time of application and being compressed during the fold formation by the bent-over outer part (11). The change in shape may be brought about, as an alternative, later, e.g., by a curing reaction, heating or the like, as a result of which tape (26) swells and fills out cavities that may be present in the area of the fold (9). It can thus form a highly efficient sealant for folds (9) in the manufacture of bodies in white for vehicle parts. Additional components that have hitherto been commonly used, such as sealers or the like, can be eliminated.

As is illustrated in FIGS. 6 and 7, fold (9) may have different shapes, and the overlap of the hemmed or folded edge of the outer part (11) may have different dimensions. This overlap may also be affected by the type of the workpiece and the particular position of the fold edge at the corner area (7), an arch (6) or a characteristic line (8). Correspondingly, the tape (26) also does not have to be applied symmetrically to the inner part (10). The leg lengths may differ on the two sides and can thus possibly be adapted to the corresponding needs of the folds. Tape (26) shown can also be adapted by stretching or possibly also by upsetting during the application in adaptation to the special shape features of the workpiece (3) or of the processing path (4) thereof, especially arches (6) with a weak curvature, corner areas (7) with greater curvature, characteristic lines (8) or the like.

In another embodiment, for example, an adhesive tape (27) can be applied to the surface of a workpiece (3). The processing or application path (4) may now have a shape differing from a flat shape and being contoured three-dimensionally, which alternates, e.g., along the course of the path. Arches towards the outside or inside and lateral curvatures in the course of the path or the like, may also be present here. This is likewise a three-dimensional application, just as in the above-described exemplary embodiment. The processing or application tool (15) may be positioned, oriented and possibly pressed on corresponding to the shape and course of the processing path (4) by the manipulator (13) in this case as well.

In the exemplary embodiment according to FIG. 4, the manipulator (13) rotating about its basic axis (I) can guide the processing or application tool (15) along the processing path (4) and correspondingly assume different orientations and kinked or stretched positions in the process. Media supply unit (16) may likewise be arranged at the carrying means (25) and permits, for example, central media feed in the area of the basic axis (I) and farther transport via corresponding feed and transport means along the manipulator (13) up to the end-side tool (15). As an alternative, the feed means of the media supply unit (16) may have an extension arm, which rotates with the manipulator (13) and transfers the medium (2, 26) at the end directly to the processing or application tool (15).

A gap or distance (35) may possibly be present between tool (15) and media supply unit (16) in the various exemplary embodiments. As an alternative or in addition, feed means (31) may be flexible and follow the motions of the tool while minimizing or avoiding the formation of a gap or distance.

Various variants of the embodiments shown and described are possible. A tape (26), especially an adhesive tape (27), may be applied to the outer part (11) and possibly bent jointly during folding as an alternative or in addition to FIGS. 5, 6 and 7.

Furthermore, the embodiments of the manipulator (13), tool (15) and media supply unit (16) may vary depending on the type of the medium (2, 26) and the particular application or processing. Processing may consist of surface treatment of the workpiece (3) or another type of application of a medium (2), which may be, e.g., liquid or pasty. Furthermore, shaping processes or joining processes may also be carried out with a corresponding tool (15), and only lightweight and possibly movable tool parts are arranged at the tool (15) and massive, other parts are arranged externally. Energy or motion can be transmitted to the tool (15) and parts thereof, e.g., hydraulically, by cables or in another manner. This energy transmission and also media transfer in this respect can be brought about by means of flexible transmission means, such as lines, cables or the like. Fluid transport from a media supply unit (16) to the application tool (15) may also be brought about by means of flexible lines or the like.

While specific embodiments of the invention have been shown and described in detail to illustrate the application of the principles of the invention, it will be understood that the invention may be embodied otherwise without departing from such principles.

1-38. (canceled)

39. A device for the web-shaped processing of workpieces for the application of a medium to a workpiece, the device comprising:
a processing tool;
a media supply unit; and
a moving means for generating a relative motion between medium supplied by the media supply unit and the workpiece, the moving means comprising a multiaxial manipulator with one or more driven, flexible axes, said manipulator guiding the processing tool.

40. A device in accordance with claim 39, wherein the processing force includes a pressing force that is maintained at a predetermined value, especially at a constant value, by the flexibility of the flexible axes.

41. A device in accordance with claim 39, wherein the flexible axes have an active compliance regulation comprising at least one of a pure force regulation and a combination of position and force regulation.

42. A device in accordance with claim 39, wherein said manipulator comprises a plurality of links, which are connected to one another in an articulated manner, and which are driven in a controlled manner.

43. A device in accordance with claim 42, wherein said manipulator comprises one or more sensors for detecting at least one of acting forces and/or torques of at least one of said links.

44. A device in accordance with claim 39, wherein said moving means comprises a holding means for holding the workpiece stationarily or nonstationarily.

45. A device in accordance with claim 39, wherein the medium supplied by the media supply unit is made in the form of a web of tape, said tape comprising an adhesive tape.

46. A device in accordance with claim 39, wherein said media supply unit is arranged separated in space from said manipulator and from said processing tool.

47. A device in accordance with claim 39, wherein said media supply unit comprises a media supply including a tape supply and a feed means for the tape.

48. A device in accordance with claim 39, wherein the processing tool comprises an application tool for applying a web-shaped medium as the medium supplied by the media supply unit.

49. A device in accordance with claim 39, wherein the processing tool comprises a guide means for shaping and applying the medium to the workpiece.

50. A device in accordance with claim 39, further comprising a heating means for heating the medium, wherein the medium is a web-shaped medium.

51. A device in accordance with claim 39, wherein the device comprises an application means for a three-dimensional application of a three-dimensionally deformed tape.

52. A method for the web-shaped processing of workpieces, the method comprising:
providing a device for the web-shaped processing of workpieces for the application of a medium to a workpiece, the device comprising a processing tool, a media supply unit and a moving means for generating a relative motion between medium supplied by the media supply unit and the workpiece, the moving means comprising a multiaxial manipulator with one or more driven, flexible axes, said manipulator guiding the processing tool;
guiding the processing tool by the multiaxial manipulator with the one or more driven, flexible axis.

53. A method in accordance with claim 52, wherein the flexible axes is regulated in terms of force or in terms of position and force.

54. A method in accordance with claim 53, wherein the medium is an adhesive tape applied to a workpiece.

55. A method in accordance with claim 54, wherein the medium is applied to the workpiece along a processing or application path.

56. A method in accordance with claim 54, wherein the adhesive tape has a cover tape removed at the media supply unit and disposed of.

57. A method in accordance with claim 52, wherein the medium is a web-shaped medium and is deformed during an application and is applied to the workpiece.

58. A method in accordance with claim 52, wherein the medium is a web-shaped medium that is heated before or during the application.
